(19) United States
(12) Patent Application Publication
(10) Pub. No.: US 2023/0167925 A1
(43) Pub. Date: Jun. 1, 2023

(54) PIPE CONNECTING ASSEMBLY

(71) Applicant: Zhejiang Sanhua Intelligent Controls Co., Ltd., Shaoxing (CN)

(72) Inventors: Xinjian WANG, Hangzhou (CN); Qihong JIN, Hangzhou (CN); Linjie HUANG, Hangzhou (CN)

(21) Appl. No.: 18/095,969

(22) Filed: Jan. 11, 2023

Related U.S. Application Data
(63) Continuation of application No. PCT/CN2021/100629, filed on Jun. 17, 2021.

(30) Foreign Application Priority Data
Jul. 23, 2020 (CN) 202010720203.3

(51) Int. Cl. F16L 13/10; F16L 55/033

(52) U.S. Cl. CPC F16L 13/103; F16L 55/033

(57) ABSTRACT

A pipe connecting assembly includes a valve body, a valve stem and a fitting pipe part. The valve body includes a first valve body part and a second valve body part. The valve body has a valve cavity. The first valve body part has a first cavity, and the second valve body part has a second cavity. The valve stem is at least partially located in the valve cavity. The valve body is provided with a valve port. The valve stem can move in the valve cavity to close or open the valve port, so that the first cavity is separated from or in communication with the second cavity. The pipe connecting assembly further includes an adhesive layer located between the fitting pipe part and the first valve body part. Such a structure is beneficial to improving the connection reliability of the pipe connecting assembly.

### CROSS-REFERENCE TO RELATED APPLICATIONS

The present application is a continuation of PCT Application No. PCT/CN2021/100629, filed on Jun. 17, 2021, entitled “Pipe Connection Assembly”, which claims priority to Chinese Patent Application No. 202010720203.3, filed on Jul. 23, 2020, entitled “valve assembly”, the disclosures of which are incorporated herein by reference in their entirety.

### TECHNICAL FIELD

The present disclosure relates to the field of air-conditioning system valves, and in particular, to a pipe connecting assembly.

### BACKGROUND

During operation of an air-conditioning system, a shut-off valve can be used to control on/off of a flow path of refrigerant. When the refrigerant flows in a pipe system, pulsation noise occurs. Therefore, a muffler needs to be installed in the pipe system to effectively reduce the pulsation noise. In related art, each of two ends of the muffler is usually welded with a connecting pipe for welding with other elements, and the shut-off valve is usually also welded with a connecting pipe for welding with other elements. The assembly formed by the muffler and the shut-off valve is fixed by means of welding the connecting pipe. The muffler is usually made of iron, the shut-off valve is usually made brass or aluminum, and the connecting pipe is usually made of copper. Accordingly, connection of different types of metals leads to serious electrochemical corrosion reaction, which affects the reliability of the entire assembly.

### SUMMARY

The present disclosure provides a pipe connecting assembly that is beneficial to the reliability of the connection between the valve body and the fitting pipe part.

The present disclosure provides a pipe connecting assembly, including a valve body, a valve stem and a fitting pipe part;

wherein the valve body includes a first valve body part and a second valve body part; the valve body includes a valve cavity, the first valve body part includes a first cavity, and the second valve body part includes a second cavity; at least a part of the valve stem is located in the valve cavity; the valve body includes a valve port; the valve stem is movable in the valve cavity to close or open the valve port, to make the first cavity be blocked from or in communication with the second cavity; and

the pipe connecting assembly further includes an adhesive layer, the adhesive layer is located between the fitting pipe part and the first valve body part, at least part area of the fitting pipe part and at least part area of the first valve body part are both in contact with the adhesive layer, in such a manner that the valve body and the fitting pipe part are bonded and fixed by the adhesive layer.

Since the pipe connecting assembly includes an adhesive layer between the fitting pipe part and the first valve body part, it is beneficial for fixing the valve body and the fitting pipe part by adhesion, so as to avoid electrochemical corrosion between the valve body and the fitting pipe part. The present disclosure can improve the connection reliability of the pipe connecting assembly.

### BRIEF DESCRIPTION OF DRAWINGS

FIG. 1 is a schematic perspective view of a pipe connecting assembly according to an embodiment of the present disclosure;

FIG. 2 is a schematic structural diagram of a valve body according to an embodiment of the present disclosure;

FIG. 3 is a schematic cross-sectional view of relevant parts of the valve body in FIG. 2 of the present disclosure;

FIG. 4 is a schematic structural diagram of a fitting pipe part according to an embodiment of the present disclosure;

FIG. 5 is a schematic diagram of a connection structure of a first sub-pipe part and a first valve body part according to an embodiment of the present disclosure;

FIG. 6 is an enlarged view of a part of the structure shown in FIG. 5 of the present disclosure;

FIG. 7 is an enlarged view of another connection structure of a first sub-pipe part and a first valve body part according to an embodiment of the present disclosure;

FIG. 8 is a schematic diagram of a second connection structure of a first sub-pipe part and a first valve body part according to an embodiment of the present disclosure;

FIG. 9 is a schematic diagram of a third connection structure of a first sub-pipe part and a first valve body part according to an embodiment of the present disclosure;

FIG. 10 is a schematic diagram of a fourth connection structure of a first sub-pipe part and a first valve body part according to an embodiment of the present disclosure; and

FIG. 11 is a schematic diagram of a fifth connection structure of a first sub-pipe part and a first valve body part according to an embodiment of the present disclosure.

The accompanying drawings which illustrate embodiments of the present disclosure are incorporated in and constitute a part of the specification, and serve to explain the principles of the present disclosure together with the specification.

### DESCRIPTION OF EMBODIMENTS

In order to make the purpose, technical solutions and advantages of the present disclosure more clear, the present disclosure will be described in further detail below in combination with the accompanying drawings and embodiments. It should be understood that the specific embodiments described herein are merely used to explain, but not to limit the present disclosure.

In related arts, the pipe connecting assembly includes a valve part and an external connecting pipe. According to common connection technology, the valve part and the external connecting pipe are connected by brazing. The valve body of the valve part can be made of brass, and the external connecting pipe is usually made of red copper. Due to the high cost of copper, the valve body is made of aluminum material according to some technologies so as to reduce costs. However, in a case where the valve body is made of aluminum, the contact and the fixing between the copper connecting pipe and the aluminum valve body by welding leads to serious electrochemical corrosion reaction of the valve part under an operation environment of the valve part, and a reliable connection between different metals, such as copper, aluminum, and the like, can not be ensured by brazing. There exists a certain risk of leakage at the welding position when operated for a long time in a humid and hot environment and in an environment where some refrigerant exists, which may affect the reliability of the valve part.

Further, the pipe connecting assembly usually includes a plastic bonnet, an elastic sealing ring installed in the valve body, etc., due to high welding temperature, the welding seam and welding heat effect may weaken the performance and the strength of the elastic sealing ring, the plastic bonnet and other structural members, which reduces the sealing performance.

In some related arts, the pipe connecting assembly includes a shut-off valve and a muffler. Each of the muffler and the shut-off valve is welded with a connecting pipe, and another connecting pipe needs to be welded between the connecting pipe of the muffler and the connecting pipe of the shut-off valve to connect the two components. As a result, the air-conditioning system has quite many welding points, and the processing procedure thereof is complicated. In order to reduce the number of the welding points, if the connecting pipe of the muffler is cancelled, and the connecting pipe of the shut-off valve is welded directly to the muffler, since the muffler is usually made of iron, and the connecting pipe is usually made of copper, these two are different metals. In order to reduce corrosion of iron, it needs to perform high-temperature spray on a surface of the muffler and at the position to which the connecting pipe is connected, to add a corrosion-resistant protective coating layer. The high temperature of the spraying process may affect the sealing effect of the sealing element(s) in the shut-off valve. However, if the connecting pipe of the shut-off valve is cancelled, and the connecting pipe of the muffler is welded directly to the shut-off valve, since the shut-off valve needs to be cleaned with brazing flux after being welded to the connecting pipe, while an inner wall of the muffler cannot be exposed to water which leads to a risk of corrosion, there are quite many problems for the welding connection ways in the related art.

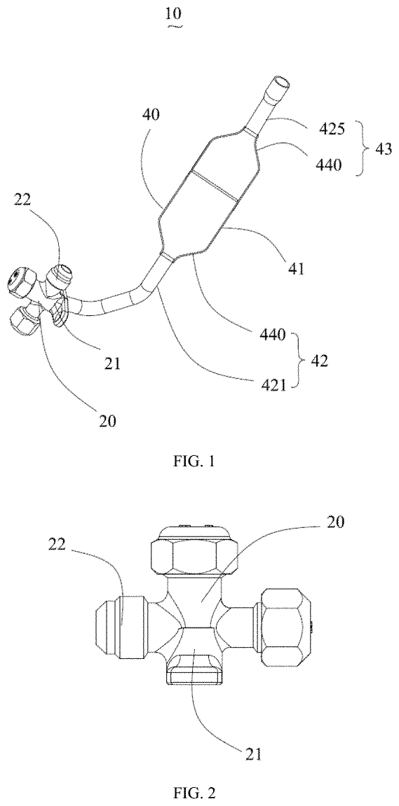

As shown in FIG. 1, an embodiment of the present disclosure provides a pipe connecting assembly 10 including a valve body 20, a valve stem 30 and a fitting pipe part 40. The valve body 20 and the fitting pipe part 40 can be of the same metal or different metals.

The valve body 20 includes a first valve body part 21 and a second valve body part 22. The valve body 20 includes a valve cavity 201. The first valve body part 21 includes a first cavity 210, and the second valve body part 22 includes a second cavity 220. Each of the first cavity 210 and the second cavity 220 is part of the valve cavity 201. At least part of the valve stem 30 is located in valve cavity 201. The valve body 20 includes a valve port 202. The valve stem 30 is movable within the valve cavity 201 to close or open the valve port 202, so that the first cavity 210 is blocked from or in communication with the second cavity 220. In some embodiments, the valve body 20 and the valve stem 30 can have functions related to a shut-off valve, and the shut-off valve can be connected to the indoor unit and the outdoor unit in the air-conditioning system to control on/off of a flow path of the refrigerant. The valve stem 30 may be provided with an external thread, and a wall surface of the valve body 20 that forms the valve cavity 201 may be provided with an internal thread matched with the external thread. Accordingly, the valve stem 30 can make reciprocating movement in the valve cavity 201 under the action of the thread pair to approach or move away from the valve port 202, so that the first cavity 210 is blocked from or in communication with the second cavity 220. In order to ensure the sealing between the valve stem 30 and the valve body 20, a soft sealing member such as an elastic sealing ring may further be provided between the valve stem 30 and the valve body 20, and a bonnet that can be matched with the valve body 20 by thread may be provided. A metal hard seal can be formed between the bonnet and the valve body 20, thereby further ensuring the sealing performance of the shut-off valve.

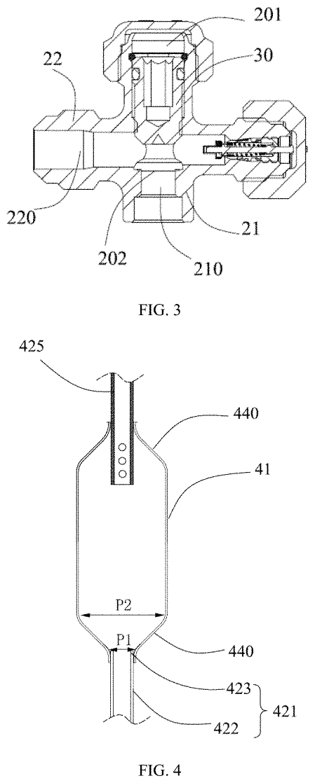

Each of the first valve body part 21 and the second valve body part 22 may have a central axis, and the two central axes may be coincident with, parallel to or perpendicular to each other, or have a certain angle. In an embodiment of the present disclosure, as shown in FIG. 3, the central axis of the first valve body part 21 is perpendicular to the central axis of the second valve body part 22.

The valve body 20 may further include a filling structure to facilitate filling the system with refrigerant, such as a right-side part of the valve body shown in FIG. 2 and FIG. 3. At least part of the filling structure is located in a cavity of the right-side part of the valve body. The filling structure may include components such as a valve core. In another embodiment, the valve body may not include the filling structure. The present disclosure does not limit this.

The fitting pipe part 40 may be a common pipe for communicating with the outside, or a functional pipe for muffling. The functional pipe for muffling is taken as an example of the fitting pipe part. As shown in FIG. 1 and FIG. 4, the fitting pipe part 40 includes a main pipe body 41, a first pipe part 42 and a second pipe part 43. The main pipe body 41 is connected between the first pipe part 42 and the second pipe part 43. A cavity of the main pipe body 41 is in communication with a cavity of the first pipe part 42 and a cavity of the second pipe part 43. Each of the first pipe part 42 and the second pipe part 43 includes a necked pipe part 440. Since a pipe diameter P1 of an end of the necked pipe part 440 away from the main pipe body 41 is smaller than a pipe diameter P2 of another end of the necked pipe part 440 adjacent to the main pipe body 41, when the fluid flows in an inner cavity of the fitting pipe part 40, abruptly changing of a cross-sectional area of the pipe is beneficial to reflecting a sound source propagating along the pipe along a direction of the sound source by taking advantage of the change of acoustic impedance, so as to reduce noise. Meanwhile, the fluid flows through a cavity of the necked pipe part 440 and then enters the cavity of the main pipe body 41. During this process, a cross-sectional area of the fluid inflow gradually increases, a flow velocity of the fluid is slow and the pressure decreases. In this way, the cavity of the main pipe body 41 forms a buffer space, which is also beneficial to reducing noise.

The first pipe part 42 further includes a first connecting pipe part 421 connected to the necked pipe part 440 of the first pipe part 42. The pipe connecting assembly 10 further includes an adhesive layer 50 located between the first connecting pipe part 421 and the first valve body part 21. At least part area of the first connecting pipe part 421 and at least part area of the first valve body part 21 are both in contact with the adhesive layer 50, so that the valve body 20 and the fitting pipe part 40 are fixed by bonding. The connection manner by bonding is beneficial to reducing the number of welding positions between the first connecting pipe part 421 and the first valve body part 21. The first connecting pipe part 421 and the necked pipe part 440 may be integrally formed. Alternatively, a part of a pipe structure of the first connecting pipe part 421 and the necked pipe part 440 may be integrally formed.

The second pipe part 43 further includes a second connecting pipe part 425 connected to the necked pipe part 440 of the second pipe part 43. As shown in FIG. 4, a part of the second connecting pipe part 425 is connected to the necked pipe part 440, a part of the second connecting pipe part 425 extends into the cavity of the main body 41, and another part of the second connecting pipe part 425 is located outside the cavity of the main body 41 and the cavity of the necked pipe part 440.

In an embodiment of the present disclosure, the first connecting pipe part 421 includes a first sub-pipe part 422 and a second sub-pipe part 423. The second sub-pipe part 423 and the necked pipe part 440 are fixed by welding or bonding. The first sub-pipe part 422 is located at a side of the second sub-pipe part 423 away from the second pipe part 43. In an example, the second sub-pipe part 423 is located in the cavity of the necked pipe part 440, and the second sub-pipe part 423 and the necked pipe part 440 form a casing structure. In this way, the processing difficulty of the fitting pipe part 40 can be simplified, and the complexity of manufacturing and processing can be reduced by splicing multiple sections of pipe parts.

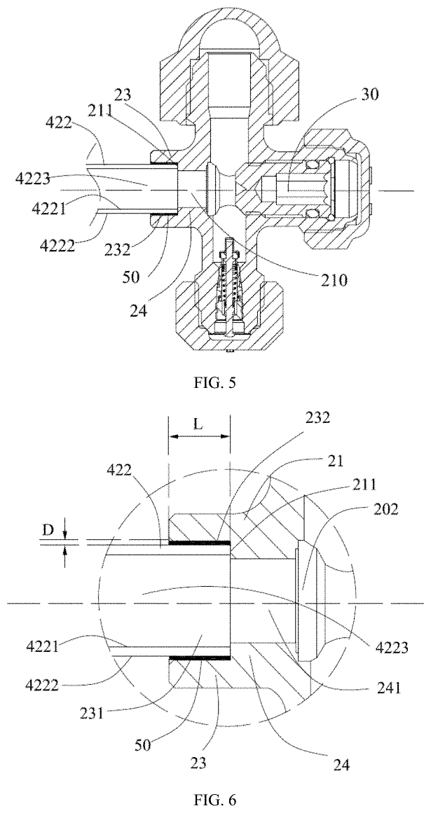

As shown in FIG. 6, the adhesive layer 50 is located between the first sub-pipe part 422 and the first valve body part 21. The valve body 20 includes a blocking surface 211, and at least part area of an end surface 4221 of the first sub-pipe part 422 away from the second sub-pipe part 423 is in contact with the blocking surface 211. The blocking surface 211 may be located at the first valve body part 21 or at other parts of the valve body 20. The blocking surface 211 can limit an installation direction of the first sub-pipe part 422, so that the first sub-pipe part 422 can be easily positioned and glued, and the stability of bonding can be improved.

The first valve body part 21 includes a first connection-fitting part 23 and a first step-fitting part 24. The first connection-fitting part 23 includes a first channel 231. The first channel 231 is a part of the first cavity 210. At a least part of the first sub-pipe part 422 is located at the first channel 231. According to the embodiment shown in FIG. 5, a part of the first sub-pipe part 422 is located inside the first cavity 210, and another part of the first sub-pipe part 422 is located outside the first cavity 210.

The first sub-pipe part 422 includes an inner surface 4221 and an outer peripheral surface 4222 that circumferentially surround the pipe cavity of the first sub-pipe part 422. At least part area of the outer peripheral surface 4222 of the first sub-pipe part 422 is in contact with the adhesive layer 50. The first connection-fitting part 23 includes an annular inner wall surface 232 for forming the first channel 231. At least part area of the annular inner wall surface 232 is in contact with the adhesive layer 50. There is a gap for accommodating the adhesive layer 50 between the outer peripheral surface 4222 of the first sub-pipe part 422 and the annular inner wall surface 232 of the first connection-fitting part 23. When gluing, the adhesive/glue can be coated on the outer peripheral surface 4222 at the end of the first sub-pipe part 422, or the annular inner wall surface 232 of the first connection-fitting part 23, or both the outer peripheral surface 4222 at the end of the first sub-pipe part 422 and the annular inner wall surface 232 of the first connection-fitting part 23. The coated adhesive/glue is cured to form the adhesive layer 50 finally.

The first step-fitting part 24 is protruded toward the first cavity 210 further than the first connection-fitting part 23. The blocking surface 211 is located at the first step-fitting part 24 and connected to the annular inner wall surface 232. For the first step-fitting part 24, in addition to limiting the first sub-pipe part 422, the blocking surface 211 can also prevent the adhesive/glue from overflowing to enter other parts of the first cavity 210. In this way, the stability of the product can be improved, and the adhesive/glue does not easily enter the space for fluid flow in the first cavity 210. Therefore, the fluid is not easily contaminated, and precision control of other components/parts of the system is not easily influenced.

The first step-fitting part 24 further includes a second channel 241. The first channel 231 and the second channel 241 together form the first cavity 210. A channel opening at a side of the second channel 241 away from the first channel 231 forms the valve port 202. The valve stem 30 can move relative to the valve port 202 along an axis direction of the second channel 241. When the valve stem 30 opens the valve port 202, the pipe cavity of the first sub-pipe part 422 is in communication with the second cavity 220 via the second channel 241.

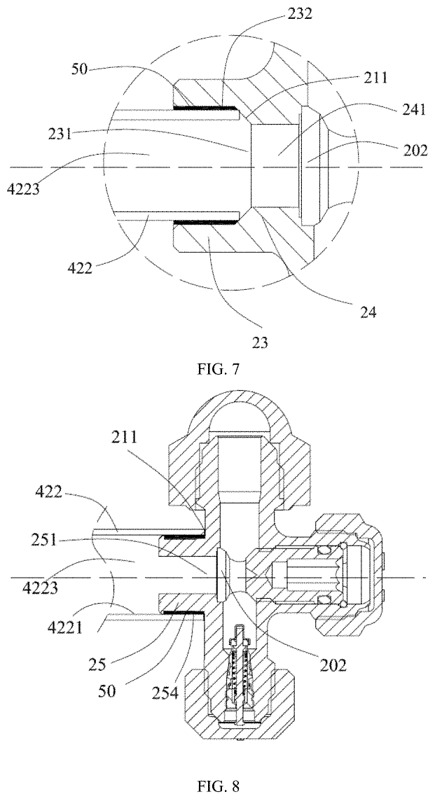

As shown in an enlarged schematic diagram shown in FIG. 6, the blocking surface 211 is perpendicular to the axis direction of the second channel 241. A height of the first step-fitting part 24 protruding relative to the annular inner wall surface 232 of the first connection-fitting part 23 is greater than a thickness of the adhesive layer 50. The inner surface 4221 of the first sub-pipe part 422 may be slightly lower than or flush with the inner wall surface of the second channel 241 formed by the first step-fitting part 24. Alternatively, as shown in FIG. 7, the blocking surface 211 is oblique with respect to the axis direction of the second channel 241, which is beneficial to reducing the flow resistance of the fluid, and thus improving the fluidity of the fluid.

As shown in FIG. 6, a length L of the adhesive layer 50 along the axis direction of the second channel 241 may be within a range from 1mm to 10 mm. In some embodiments, the length L of the adhesive layer 50 along the axis direction of the second channel 241 may be within a range from 2.5 mm to 5 mm. A thickness D of the adhesive layer 50 may be within a range from 0.05 mm to 1 mm. In some embodiments, the thickness D of the adhesive layer 50 may be within a range from 0.15 mm to 0.35 mm. In this way, the strength of the connection between the first sub-pipe part 422 and the first valve body part 21 can be increased by configuring the length of the adhesive layer 50 along the axis direction of the second channel 241 and the thickness of the adhesive layer 50 within a certain range. A material of the adhesive layer 50 may be a high-strength epoxy-based double-component structural adhesive or a high-strength epoxy-based single-component structural adhesive.

In other embodiments of the present disclosure, the first sub-pipe part 422 includes a first sub-cavity 4223 extending through the pipe body thereof. The first valve body part 21 includes a tubular fitting part 25. The tubular fitting part 25 includes a third channel 251. The third channel 251 is at least a part of the first cavity 210. The valve body may further be provided with a second step-fitting part to fit with the tubular fitting part 25, or the first sub-pipe part 422 can be position-limited by a surface structure of the valve body.

As shown in FIG. 8, at least a part of the tubular fitting part 25 is located in the first sub-cavity 4223. At least part area of the outer peripheral wall of the tubular fitting part 25 is in contact with the adhesive layer 50. At least part area of the inner surface 4221 of the first sub-pipe part 422 which forms the first sub-cavity 4223 is in contact with the adhesive layer 50. The blocking surface 211 is located at the valve body 20, and is connected to the outer peripheral wall of the tubular fitting part 25.

In order to prevent the adhesive/glue from overflowing to enter the space of the first sub-cavity 4223 of the first sub-pipe part 422 and the third channel 251 for fluid flow. The tubular fitting part 25 may be provided with an accommodating groove 254. The accommodating groove 254 opens toward the inner surface 4221 of the first sub-pipe part 422. At least a part of the adhesive layer 50 is located at the accommodating groove 254. The accommodating groove 254 may have an opening only at the top. The first sub-pipe part 422 blocks the opening of the accommodating groove 254. In order to ensure the thickness of adhesive/glue, a depth of the accommodating groove 254 is within a range from 0.05mm to 1mm. In some embodiments, the depth of the accommodating groove 254 is within a range from 0.15mm to 0.35mm. In other words, the depth of the accommodating groove 254 ensures that the thickness of the adhesive/glue meets the gluing requirements. Adhesive/glue is protected from overflowing by the first sub-pipe part 422 through the side wall connected to the groove bottom of the accommodating groove 254, so that the adhesive/glue does not easily leak to the space of the third channel 251 for fluid flow. The length of the accommodating groove 254 along the axis direction of the third channel 251 is within a range from 1mm to 10 mm, which is beneficial to ensuring the gluing area, and thus ensuring the strength of the connection between different components/parts. In some embodiments, the length of the accommodating groove 254 along the axis direction of the third channel 251 may be within a range from 2.5mm to 5mm. A material of the adhesive layer 50 is a high-strength epoxy-based two-component structural adhesive or a high-strength epoxy-based single-component structural adhesive.

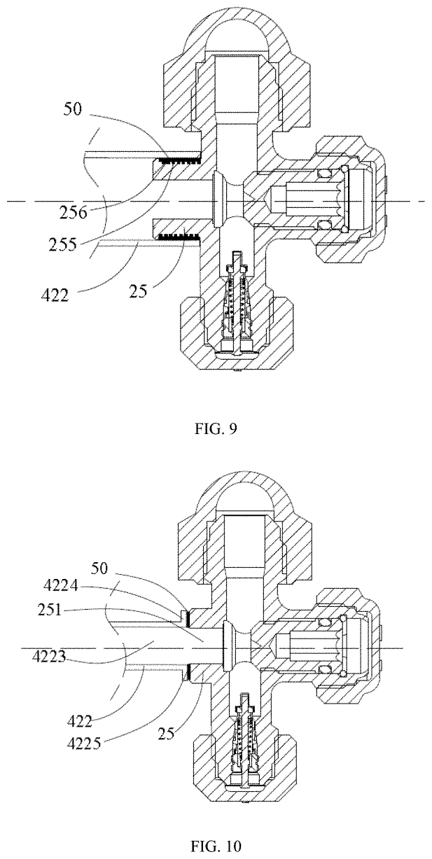

As shown in FIG. 9, in some other embodiments of the present disclosure, a plurality of recesses 255 are provided at a side of the tubular fitting part 25 away from an axis line of the third channel 251, and a protrusion 256 is formed between two adjacent recesses 255. The recess 255 opens toward the inner surface 4221 of the first sub-pipe part 422. Two adjacent recesses 255 are separated by the protrusion 256. The plurality of the recesses 255 and a plurality of the protrusions 256 form an uneven tongue-and-groove surface on at least part area of the side of the tubular fitting part 25 away from the axis line of the third channel 251. The tongue-and-groove surface can be provided at the groove bottom of the accommodating groove 254 shown in FIG. 8, or be provided directly at a surface of the side of the tubular fitting part 25 away from the third channel 251. The tongue-and-groove surface facilitates the adhesive layer 50 to improve the strength of the connection between the tubular fitting part 25 and the first sub-pipe part 422, and can prevent overflowing of the adhesive/glue to some extent.

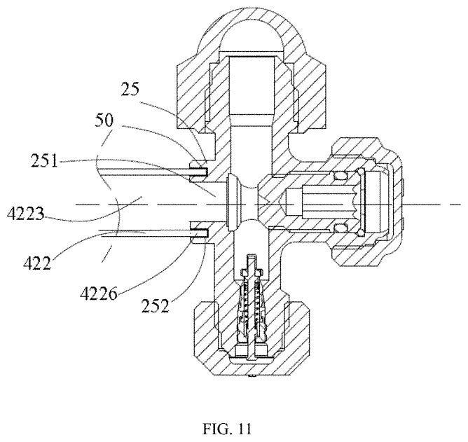

In addition to the fixing manner in which the first connecting pipe part 421 and the first valve body part 21 are fixed by bonding through the adhesive layer 50 in the central axis direction of the first valve body part 21, in some other embodiments of the present disclosure, the first sub-pipe part 422 may include a first sub-cavity 4223 extending through the pipe body thereof, the first valve body part 21 may include a tubular fitting part 25 including a third channel 251, the third channel 251 is at least a part of the first cavity 210, the third channel 251 is in communication with the first sub-cavity 4223, and as shown in FIG. 10, the first connecting pipe part 421 and the first valve body part 21 can also be fixed by bonding through the adhesive layer 50 in a direction perpendicular to the central axis of the first valve body part 21. That is, the adhesive layer 50 is disposed between an end surface 4225 of a free end of the connecting pipe part 421 and the first valve body part 21. The free end of the first connecting pipe part 421 may have an outer flange 4224 facing a direction away from the first sub-cavity 4223, and an end surface 4225 is formed at a side of the outer flange 4224 facing toward the first valve body part 21. The end surface 4225 may be perpendicular to the axis direction of the third channel 251. In order to prevent overflowing of the adhesive, the first connecting pipe part 421 may also be provided with a protrusion located at for example a side of the adhesive layer 50 adjacent to the central axis of the third channel 251, or, the first valve body part 21 may be provided with a protrusion located at a side of the adhesive layer 50 adjacent to the central axis of the third channel 251, and so on.

In other embodiments, as shown in FIG. 11, the first sub-pipe part 422 includes a first sub-cavity 4223 extending through the pipe body thereof. The first valve body part 21 includes a tubular fitting part 25. The tubular fitting part 25 includes a third channel 251. The third channel 251 is at least a part of the first cavity 210. The third channel 251 is in communication with the first sub-cavity 4223. The first valve body part 21 may be provided with a groove 252. The groove 252 is located at an outer periphery of the third channel 251. The first sub-pipe part 422 includes an accommodation-fitting part 4226 matched with the groove 252. The accommodation-fitting part 4226 can be accommodated in the groove 252. At least a part of the adhesive layer 50 is also accommodated in the groove 252. The adhesive layer 50 is located between the accommodation-fitting part 4226 and a groove wall of the groove 252. In an example, a surface of the accommodation-fitting part 4226 may be coated with adhesive/glue, and then the accommodation-fitting part 4226 is inserted into the groove 252. The accommodation-fitting part 4226 and the groove wall of the groove 252 are both in contact with the adhesive layer 50, so that the accommodation-fitting part 4226 and the groove 252 are fixed by bonding through the adhesive layer 50.

The first sub-pipe part 422 may be made of a material including one or more of iron, copper alloy, and aluminum alloy. The first sub-pipe part 422 may also be made of non-metal. In this way, when the material of the valve body 20 is different from that of the pipe body part, which is for example the main body 41 for realizing the noise reduction function, the difficulty of welding different types of metal materials and electrochemical corrosion caused by welding different types of metal materials can be reduced.

In addition, in some embodiments of the present disclosure, the first sub-pipe part 422 may be a complete connecting pipe extending as a whole, which reduces the number of components/parts of the connecting pipe when connecting the shut-off valve and the muffler in the related art, and thus facilitating integrated design. In some embodiments of the present disclosure, the length of the first sub-pipe part 422 may be reduced or the first sub-pipe part 422 may even be eliminated, so as to reduce a distance between the necked pipe part 440 of the muffler and the valve body 20 of the shut-off valve, thereby reducing a space occupied by the system. The first connecting pipe part 421 and the first valve body part 21 are fixed by using the adhesive layer 50, so as to reduce the number of welding positions of the entire air-conditioning system, and thus simplifying the welding process. The connection parts are sealed by using the adhesive layer 50, which brings the advantages of simple manufacturing and good sealing effect, and reduces a risk of electrochemical corrosion caused by different types of metals. The first connecting pipe part 421 and the first valve body part 21 of the pipe connecting assembly can be fixedly connected by reserving certain curing time after gluing, which significantly reduces the brazing positions and processes of an original brazing process, and thus is beneficial to improving the production efficiency of products, reducing the number of connecting pipes and saving the cost.

The above descriptions are merely some preferred embodiments of the present disclosure, and are not intended to limit the present disclosure. For those skilled in the art, the present disclosure may have various modifications and variations. Any modification, equivalent replacement, improvement, etc. made within a concept of the present disclosure shall fall into a scope of the present disclosure.

What is claimed is:

1. A pipe connecting assembly, comprising a valve body, a valve stem and a fitting pipe part;
wherein the valve body comprises a first valve body part and a second valve body part, the valve body comprises a valve cavity, the first valve body part comprises a first cavity, the second valve body part comprises a second cavity; at least a part of the valve stem is arranged in the valve cavity, the valve body is provided with a valve port, and the valve stem is movable in the valve cavity to close or open the valve port, to make the first cavity be blocked from or in communication with the second cavity; and
the pipe connecting assembly further comprises an adhesive layer provided between the fitting pipe part and the first valve body part, wherein at least part area of the fitting pipe part and at least part area of the first valve body part are both in contact with the adhesive layer, in such a manner that the valve body and the fitting pipe part are bonded and fixed by the adhesive layer.

2. The pipe connecting assembly according to claim 1, wherein the valve body is made of aluminum, and the fitting pipe part is made of copper or copper alloy.

3. The pipe connecting assembly according to claim 1, further comprising a main body, a first pipe part, and a second pipe part;
wherein the main body is connected between the first pipe part and the second pipe part, a cavity of the main body is in communication with a cavity of the first pipe part and a cavity of the second pipe part; each of the first pipe part and the second pipe part comprises a necked pipe part; the first pipe part further comprises a first connecting pipe part connected to the necked pipe part; and a pipe diameter of an end of the necked pipe part away from the main body is smaller than a pipe diameter of another end of the necked pipe part adjacent to the main body.

4. The pipe connecting assembly according to claim 3, wherein the first connecting pipe part comprises a first sub-pipe part and a second sub-pipe part connected with each other; the second sub-pipe part and the necked pipe part are fixed by welding or bonding; the first sub-pipe part is arranged at a side of the second sub-pipe part away from the second pipe part, and the adhesive layer is arranged between the first sub-pipe part and the first valve body part; and
wherein the valve body comprises a blocking surface, and an end surface of the first sub-pipe part away from the second sub-pipe part is in contact with at least part area of the blocking surface.

5. The pipe connecting assembly according to claim 4, wherein the first valve body part comprises a first connection-fitting part and a first step-fitting part; the first connection-fitting part comprises a first channel; and the first channel is a part of the first cavity; and
at least a part of the first sub-pipe part is arranged at the first channel; at least part area of an outer peripheral surface of the first sub-pipe part is in contact with the adhesive layer; the first connection-fitting part comprises an annular inner wall surface for forming the first channel, and at least part area of the annular inner wall surface is in contact with the adhesive layer; the first step-fitting part is protruded toward the first cavity further than the first connection-fitting part; and the blocking surface is arranged at the first step-fitting part and connected to the annular inner wall surface.

6. The pipe connecting assembly according to claim 5, wherein the first step-fitting part comprises a second channel, the first channel and the second channel form the first cavity together, a channel opening at a side of the second channel away from the first channel forms the valve port, the valve stem is movable with respect to the valve port along an axis direction of the second channel, and the second channel is in communication with a cavity of the first sub-pipe part and the valve cavity when the valve port is opened through the valve stem.

7. The pipe connecting assembly according to claim 6, wherein the blocking surface is perpendicular to the axis direction of the second channel, or the blocking surface is oblique with respect to the axis direction of the second channel.

8. The pipe connecting assembly according to claim 6, wherein a length of the adhesive layer along the axis direction of the second channel is within a range from 1 mm to 10 mm, and a thickness of the adhesive layer is within a range from 0.05 mm to 1 mm.

9. The pipe connecting assembly according to claim 6, wherein the adhesive layer is made of an epoxy-based double-component structural adhesive or an epoxy-based single-component structural adhesive.

10. The pipe connecting assembly according to claim 4, wherein the first sub-pipe part comprises a first sub-cavity extending through a pipe body thereof, the first valve body part comprises a tubular fitting part, the tubular fitting part comprises a third channel, and the third channel is at least a part of the first cavity; at least a part of the tubular fitting part is located at the first sub-cavity, at least part area of the tubular fitting part is in contact with the adhesive layer, and at least part area of an inner surface of the first sub-pipe part forming the first sub-cavity is in contact with the adhesive layer.

11. The pipe connecting assembly according to claim 10, wherein the tubular fitting part is provided with an accommodating groove, an opening of the accommodating groove opens toward the inner surface of the first sub-pipe part, the adhesive layer is at least partially located at the accommodating groove, and the first sub-pipe part blocks the opening of the accommodating groove.

12. The pipe connecting assembly according to claim 11, wherein a depth of the accommodating groove is within a range from 0.05 mm to 1 mm, and a length of the accommodating groove along an axis direction of the third channel is within a range from 1 mm to 10 mm.

13. The pipe connecting assembly according to claim 11, wherein a plurality of recesses are provided at a side of the tubular fitting part away from the third channel, an opening of each of the recesses opens toward the inner surface of the first sub-pipe part, and a protrusion is formed between two adjacent ones of the recesses, the plurality of recesses and a plurality of protrusions form an uneven tongue-and-groove surface on at least part area of a side of the tubular fitting part away from the third channel.

14. The pipe connecting assembly according to claim 4, wherein the first sub-pipe part comprises a first sub-cavity extending through a pipe body thereof, the first valve body part comprises a tubular fitting part, the tubular fitting part comprises a third channel, and the third channel is at least a part of the first cavity; and
the first sub-pipe part is provided with an outer flange facing a direction away from the first sub-cavity, at least part area of an end surface of the outer flange facing toward the first valve body part is in contact with the adhesive layer, and at least part area of the tubular fitting part is in contact with the adhesive layer.

15. The pipe connecting assembly according to claim 4, wherein the first sub-pipe part comprises a first sub-cavity passing through a pipe body thereof, the first valve body part comprises a tubular fitting part, the tubular fitting part comprises a third channel, and the third channel is at least a part of the first cavity; and
the tubular fitting part is provided with a groove, the groove is arranged at a periphery of the third channel, the first sub-pipe part comprises an accommodation-fitting part, the accommodation-fitting part is accommodated in the groove, at least a part of the adhesive layer is accommodated in the groove, at least part area of the accommodation-fitting part is in contact with the adhesive layer, and at least part area of a groove wall of the groove is in contact with the adhesive layer.

16. A pipe connecting assembly, comprising:
a valve body comprising a first valve body part, a second valve body part, a valve cavity and a valve port, wherein the first valve body part comprises a first cavity, and the second valve body part comprises a second cavity;
a valve stem, wherein at least a part of the valve stem is arranged in the valve cavity, and the valve stem is movable in the valve cavity to close or open the valve port, to make the first cavity be blocked from or in communication with the second cavity;
a fitting pipe part; and
an adhesive layer provided between the fitting pipe part and the first valve body part;
wherein at least a part of the fitting pipe part and at least a part of the first valve body part are both in contact with the adhesive layer, in such a manner that the valve body and the fitting pipe part are bonded and fixed by the adhesive layer.

17. A pipe connecting assembly, comprising:
a valve body comprising a first valve body part defining a first cavity and a second valve body part defining a second cavity, the valve body defining a valve cavity and a valve port;
a valve stem being received in the valve cavity, the valve stem being movable in the valve cavity to close or open the valve port, to make the first cavity be blocked from or in communication with the second cavity;
a fitting pipe part being in fluidic communication with the first cavity or the second cavity; and
an adhesive layer being sandwiched between the fitting pipe part and the valve body;
wherein the fitting pipe part and the first valve body part are in connection with two opposite sides of the adhesive layer, respectively; and the fitting pipe part and the valve body are made of different metal materials.

18. The pipe connecting assembly according to claim 17, wherein the valve body is made of aluminum, the fitting pipe part is made of copper or copper alloy, and the adhesive layer is made of an epoxy-based double-component structural adhesive or an epoxy-based single-component structural adhesive.

19. The pipe connecting assembly according to claim 17, wherein the fitting pipe part comprises a first pipe part, a second pipe part, and a muffler, the muffler comprising a main body connected between the first pipe part and the second pipe part;
wherein the second pipe part being retained to the valve body through the adhesive layer.

20. The pipe connecting assembly according to claim 19, wherein a cavity of the main body is in communication with a cavity of the first pipe part and a cavity of the second pipe part; each of the first pipe part and the second pipe part comprises a necked pipe part; and the first pipe part comprises a first connecting pipe part connected to the necked pipe part;
wherein a pipe diameter of an end of the necked pipe part away from the main body is smaller than a pipe diameter of another end of the necked pipe part adjacent to the main body.
